(19) United States
(12) Patent Application Publication
(10) Pub. No.: US 2003/0157259 A1
(43) Pub. Date: Aug. 21, 2003

(54) Processes for coating superconducting films on devices

(76) Inventor: Arun K. Mehrotra, Naperville, IL (US)

Correspondence Address: MARSHALL, GERSTEIN & BORUN, 6300 SEARS TOWER, 233 SOUTH WACKER, CHICAGO, IL, 60606-6357, US

(21) Appl. No.: 10/079,652

(22) Filed: Feb. 20, 2002

(51) Int. Cl. B32B 18/00; B05D 5/12; B05D 1/36; B05D 3/02

(52) U.S. Cl. 427/402; 428/701; 427/372.2; 505/470

(57) ABSTRACT

A method for coating a device with superconducting material is disclosed. The method includes coating a thin pre-layer of superconducting material on the device, heat treating the thin pre-layer, coating a second layer on the heat-treated thin pre-layer and heat treating the second and thin pre-layers. The method prevents or substantially prevents bleeding of superconducting material into uncoated regions of the device. Another disclosed method involves the mechanical polishing of the device prior to coating with the superconducting material. Such a preliminary mechanical polishing reduces scratches and surface defects which, by way of capillary action, can contribute to the bleeding of the superconducting material from a coated region into an uncoated region of the device.

### TECHNICAL FIELD

The present invention relates generally to superconducting materials, and more particularly to methods of manufacturing structures partially coated with high-temperature superconducting materials. Still more specifically, the present invention relates to the coating of high-temperature superconducting materials on devices using a multiple step process including the coating of a thin pre-layer of superconducting material on the device, heat treating the device and pre-layer, coating a second thicker layer of superconducting material on the heat-activated pre-layer and heat treating the resultant structure. A method that includes the coating of superconducting materials on a polished or mechanically polished device.

### BACKGROUND

The discovery that certain ceramic materials exhibit superconductivity at above liquid nitrogen temperatures has stimulated intensive research. One such ceramic material is YBa₂Cu₃O₆₊ₓ where x ranges from 0 to 1 or “YBCO.” Many uses for such materials have been suggested and attempted, including, for example, devices operating with microwave or radio frequency signals such as antennas, magnetic resonance imaging pickup coils, resonators, and the like. Optimal performance of such devices may depend upon having the lowest possible surface resistance.

Low-surface resistance high-temperature superconducting materials have been successfully fabricated in the form of thin films of ceramic material. Such films typically have a thickness on the order of 0.5 μm and are formed by depositing the ceramic material or its precursors on the surface of a planar, single crystal devices using techniques such as co-evaporation, sputtering, laser ablation, and molecular beam epitaxy. These techniques are expensive and difficult to control.

U.S. Pat. Nos. 5,789,347 and 6,119,025 disclose melt processing or melt texture techniques for thick films. The melt texture process of the '347 and '025 patents involves heating a film that contains YBCO starting materials or precursor materials on a zirconia ceramic device at a temperature above 1015° C. in pure oxygen. The film is applied by doctor blading. The heat treatment is fast and relatively simple, but it cannot be used on common metallic devices with low melting points due to the extreme temperatures (>1015° C.) required to generate the YBCO in the film. The typical surface resistance of the flat films produced by the melt texture process of the '347 and '025 patents are about 0.1 milliohms while the surface resistance of small diameter curved surfaces, e.g., 1-3 mm diameter, is somewhat higher, about 0.3 milliohms. The coatings disclosed in the '347 and '025 patents are applied by screen printing, painting, doctor blading or spin coating.

U.S. Pat. Nos. 5,340,797 and 5,527,765 disclose a “reactive texture” process which involves forming films on metallic devices from compounds containing constituents of YBCO. The device and films are then heated to near 900° C. which results in a decomposition of the compounds containing constituents of YBCO and the crystallization of YBCO or the device. Devices are typically stainless steel or INCONEL™ (a.k.a. PYROMET™) which require thick silver plating before the application of the YBCO film. The heat treatment requires multiple gas changes including a warm-up in carbon dioxide. The dwell is typically performed in a 2 Torr oxygen atmosphere, but it is claimed to work in higher oxygen concentrations all the way up to pure oxygen. The process is very sensitive and can be difficult to control.

U.S. Pat. No. 5,856,277 discloses a “surface texture” process which is a way to alter the surface of a bulk pellet of YBCO. The top layer of the resulting structure is typically much thicker than the film produced in the melt texture, surface texture and reactive texture processes discussed above.

The melt process, surface texture and reactive texture processes all utilize some degree of recrystallization. The YBCO grain size in the surface texture process of the '277 patent is typically somewhat smaller than that of the melt texture and reactive texture processes, but the surface resistance is about the same as in the other two texturing methods.

Conventional sinter processes use the same devices and temperatures as the reactive texture process of the '797 and '765 patents but such conventional sinter processes use only phase-pure YBCO and do not involve melting any portion of the film. There is a single gas change at the end of the dwell time at maximum temperature when oxygen concentration is switched from a 1% oxygen atmosphere to a pure oxygen atmosphere. Conventional sinter processes are typically easy to perform but result in films with a resistivity that is significantly higher than that obtained by the melt process, reactive texture and surface texture processes. However, the surface resistance provided by the conventional sinter processes is superior to that of ordinary conductors such as copper or silver, even at 77° K. Unlike the melt texture, reactive texture and surface texture processes, the YBCO grains produced by the conventional sintering processes are microscopic and randomly oriented, thus resulting in higher surface resistance.

The '347, '025, '797, '765 and '277 patents are all owned by the assignee of the present application and the disclosures of said patents are incorporated herein by reference.

Dip coating processes have also been recently developed which include superconductive coatings with a satisfactory resistance that can be applied by a dip coating the device. Specifically, U.S. patent application Ser. No. 09/799,781 discloses a dip coating superconducting ink formulation that comprises terpineol, butoxyethyl acetate, one or more binders, one or more dispersants, YBa₂Cu₃O₆₊ₓ and an alcohol. U.S. patent application Ser. No. 09/799,962 disclosed an automated system for dip coating superconducting materials on a device. U.S. patent application Ser. No. 09/800,051 discloses a formulation for dip coating an unreacted superconducting coating on a device. The disclosed formulation comprises terpineol, butoxyethyl acetate, one or more binders and phase pure YBa₂Cu₃O₆₊ₓ powder. U.S. patent application Ser. No. 09/799,782 discloses a formulation for dip coating an unreacted superconductor precursor coating on a device. That disclosed formulation comprises terpineol, butoxyethyl acetate, one or more binders and unreacted YBa₂Cu₃O₆₊ₓ precursor materials.

The four above-referenced patent applications are all owned by the assignee of the present application and the disclosures of said applications are also incorporated herein by reference.

A common problem arises during the heat treating (i.e. melt texturing) of the superconducting films that partially cover a substrate. That common problem is the bleeding of the superconducting material from the portions of the device that are intended to be coated to portions of the device that are intended to be uncoated.

Specifically, resonators used in resident cavity filters typically include a body portion that serves as a conductive element and a tab used to mount the resonator within the cavity of a filter housing. It is important that the mounting tab not be coated because the coating of the tab compromises the RF properties of the filter. However, during the heat treatment of the coated superconductor material, the superconductive material tends to bleed or leak onto the previously uncoated tab area. This bleeding substantially compromises the performance of the resonator as the RF properties of the resonator are degraded.

Other causes of bleeding have been associated with scratches or imperfections in the device surface. The scratches or imperfections can act as capillaries to facilitate the migration of molten superconducting material away from the coated area of the device and onto areas which are intended to be uncoated.

Accordingly, there is a need for an improved process for coating superconducting materials on devices which prevents and/or reduces the aforenoted bleeding problem.

### SUMMARY OF THE DISCLOSURE

The present invention satisfies the aforenoted needs by providing a number of improved processes for coating superconducting materials on devices which eliminates and/or reduces the bleeding of superconducting materials from a coated area of the device into uncoated regions of the device.

One disclosed method comprises the steps of providing a device, coating a thin pre-layer of a superconducting material on at least a portion of the device, heat treating the thin pre-layer, coating a second layer of the superconducting material on the heat treated thin pre-layer and heat treating the second layer and the pre-layer. In the above-described method, the heat treating of the thin pre-layer is carried out a lower temperature than the heat treating of the combined second and pre-layers. Specifically, the heat treating of the thin pre-layer may be carried out temperatures of less than 1000° C., preferably less than 900° C., more preferably in the range of 750° C. to about 850° C., still more preferably about 800° C. The heat treating of the second layer is carried out at a higher temperature, from about 1000° C. to about 1100° C., more preferably at a temperature of about 1060° C.

The thickness of the pre-layer can vary from about 250 Å to about 750 Å, more preferably about 500 Å. A combined thickness of the thin pre-layer and second layer ranges from about 40 μm to about 100 μm.

To further reduce any capillary action caused by scratches or imperfections in the device surface on which the thin layer and second layers are deposited, the method may be further refined by providing a polished device or carrying out a mechanical polishing of the device as a preliminary step of the process.

Another disclosed method comprises providing a device, mechanically polishing the device, coating at least one layer of superconducting material on at least a portion of the device leaving another portion of the device uncoated and heat treating the coated superconducting material. In this refinement, the coating of the at least one layer of superconducting material may comprised the coating of a thin pre-layer and subsequent coating of a second layer as discussed above and separate heat treatments of the thin pre-layer and combined second and thin pre-layer as discussed above.

### BRIEF DESCRIPTION OF THE DRAWINGS

FIG. 1 is a perspective view of a resonator that comprises a device partially coated with a superconducting material in accordance with the disclosure;

FIG. 2 is a plan view of another resonator that comprises a device at least partially coated with a superconducting material in accordance with the disclosure; and

FIG. 3 is a partial side schematically illustrating a device partially coated with a thin pre-layer and a second layer of a superconducting material.

### DETAILED DESCRIPTION OF THE PRESENTLY PREFERRED EMBODIMENTS

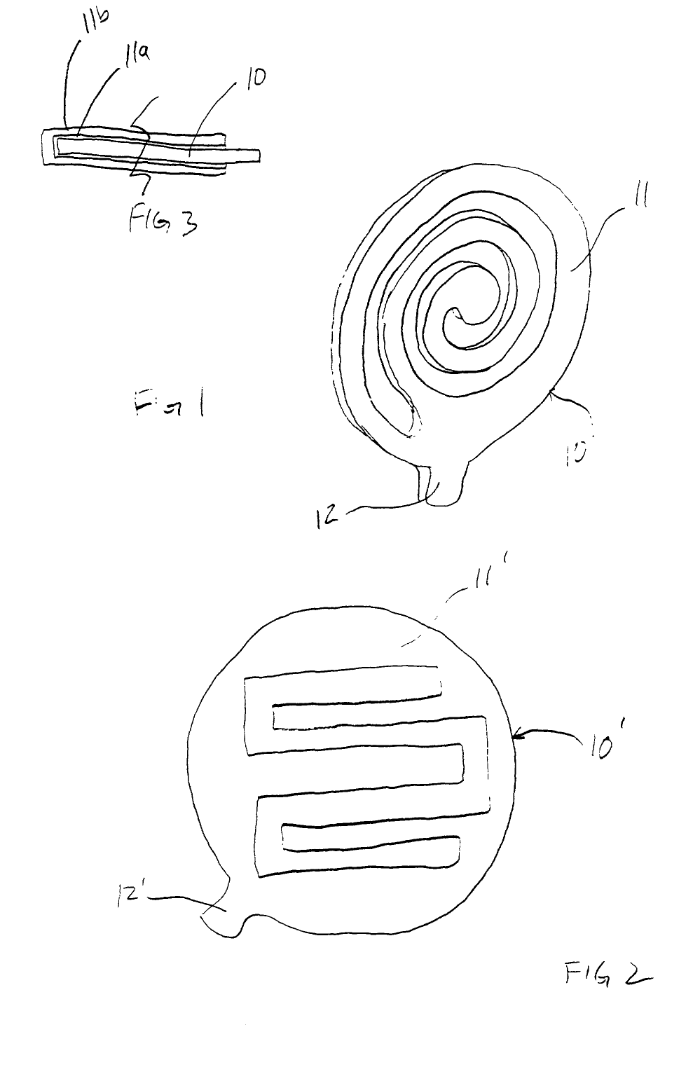

A multiple step process for coating a superconducting film on a device such as the device 10 or 10′ shown in FIGS. 1 and 2 is disclosed. It will be noted that the devices 10 include conductive portions 11, 11′, respectively, and uncoated tab portions 12 and 12′, respectively. The tab portions 12 and 12′ are used to mount the devices 10, 10′, which serve as resonators, in a filter housing. The coating of superconducting material on the tabs 12 and 12′ and subsequent heat treatment of the superconducting material would compromise the structural integrity of the tabs 12, 12′. Further, any “bleeding” of superconductive material from the conductive portions 11, 11′ into the tab portions 12, 12′, which would result in an extremely thin or partial coating of superconducting material on the tabs 12, 12′ would result in degradation of the RF properties of the resonators 10, 10′.

Accordingly, a way to minimize the above-described bleeding is disclosed. One disclosed method involves the coating of a thin pre-layer of superconducting material on the device. The thin pre-layer is heat treated at a relatively low temperature, such as 800° C. The heat treating temperature can vary, but is preferably less than 1000° C. and preferably in the range of 750° C. to 850° C. The thickness of the thin pre-layer can also vary which should range from 250 Å to about 750 Å. A preferred thickness is about 500 Å. By providing a pre-layer of superconducting material on the device surface, the amount of superconducting material initially deposited on the device surface is limited and therefore the amount of bleeding is limited. Then, a second thicker layer is deposited on the heat treated thin pre-layer. The thickness of the second layer can vary, but the combined thickness of the second and thin pre-layers, which become an essentially homogeneous single layer after heat treatment, ranges from about 40 μm to about 100 μm. Because the fresh superconducting material in the “second layer” is deposited on a heat treated superconducting pre-layer, the amount of bleeding is controlled, if not eliminated. The heat treatment of the second layer, or the heat treatment of the combined second and pre-layers, is carried out at a higher temperature than the heat treatment of the pre-layer. The higher heat treatment layer for the second and pre-layers ranges from about 1000° C. to about 1100° C., preferably at a temperature of about 1060° C.

FIG. 3 illustrates a device 10 coated with a thin pre-layer 11a of superconducting material and a second, thicker layer 11b of superconducting material.

Another disclosed method for reducing or eliminating bleeding is reducing or eliminating scratches or surface defects in the device. The method may comprise mechanically polishing the device. Specifically, when zirconia devices are used, the zirconia devices may be pre-polished or an additional polishing step may be incorporated into the methods described above. A chemical mechanical polishing treatment is not necessary. Suitable mechanical polishing systems for zirconia devices will be apparent to those skilled in the art. By polishing the device prior to the coating of a superconducting material thereon, capillary action caused by scratches and imperfections in the device surface is eliminated, thereby eliminating or substantially alleviating the bleeding problem discussed above. The superconducting material coated onto the device is preferably a high temperature superconductive (HTS) material such as YBCO.

One formulation for dip coating devices, including three dimensional devices and other devices, includes a vehicle mixed with unreacted YBCO precursor powder so that the formulation comprises from about 71 wt % to about 73 wt % unreacted YBCO precursor powder and from about 27 wt % to about 29 wt % of a vehicle. The vehicle comprises from about 47 wt % to about 49 wt % terpineol, from about 47 wt % to about 49 wt % butoxyethyl acetate and from about 2 wt % to about 4 wt % of a binder. The unreacted YBCO precursors include Y₂O₃, BaCO₃ and CuO. The terpineol and butoxyethyl acetate serve as solvents. The terpineol is preferably alpha-terpineol and the butoxyethyl acetate is preferably 2-butoxyethyl acetate. The preferred binders are acryloid, more preferably B-67™ acryloid and cellulose, more preferably T-200™ cellulose. Preferably, the vehicle and the dip coating formulation are free of dispersants as they are deemed unnecessary. The disclosed process and formulation are especially adaptable for use on yttria (partially stabilized) zirconia devices.

One preferred dip coating formulation is as follows:

| | Preferred Weight % |
|---|---|
| Vehicle | |
| Alpha-terpineol | 48.72 |
| 2-Butoxyethyl acetate (a.k.a. “BCA”) | 48.72 |
| B-67 ™ acryloid (a.k.a. “paraloid”) | 1.28 |
| T-200 ™ ethylcellulose | 1.28 |
| Dip Coating of Ink Formulation | |
| unreacted YBa₂Cu₃O₆₊ₓ Precursor (a.k.a. | 72 |
| “YBCO precursor”) | |
| Vehicle | 28 |

Generally, the solvents content control the viscosity of the dip coating ink or formulation. Accordingly, additional solvent will be required for the thinner pre-layer and less solvent will be required for the thicker second layer.

Another formulation for dip coating complex three dimensional devices and other devices includes terpineol in an amount ranging from about 6 wt % to about 8 wt %, butoxyethyl acetate in an amount ranging from about 6 wt % to about 8 wt % and alcohol, preferably ethanol, in an amount ranging from about 18 wt % to about 20 wt %. The terpineol, butoxyethyl acetate and ethanol serve as solvents. The terpineol is preferably alpha-terpineol and alcohol is preferably ethanol and more preferably anhydrous ethanol. The formulation also includes binders such as acryloid in amount ranging from about 0.2 wt % to about 0.5 wt % and ethylcellulose in an amount ranging from about 0.2 wt % to about 0.5 wt %. The acryloid is preferably B-67 acryloid and the ethylcellulose is preferably T-200 ethylcellulose. At least one dispersant is also employed in an amount ranging from about 0.5 wt % to about 2 wt %. The dispersant is preferably Emcol, more preferably Emcol CC-42. The superconductive material is preferably YBa₂Cu₃O₆₊ₓ or YBCO, also known as 123. However, other superconducting materials other than YBCO and other powdered materials used in coatings may be substituted fro the YBCO. The YBCO is preferably provided in an amount ranging from about 60 wt % to about 70 wt %.

Another preferred dip coating formulation is as follows:

| Ink Component Name | Preferred Weight % |
|---|---|
| Alpha-terpineol | 7.0 |
| Butoxyethyl acetate (a.k.a. “BCA”) | 7.0 |
| B-67 acryloid (a.k.a. “paraloid”) | 0.37 |
| T-200 ethylcellulose | 0.37 |
| Emcol CC-42 | 1.17 |
| YBa₂Cu₃O₆₊ₓ (a.k.a. “YBCO” or “123”) | 65.15 |
| Anhydrous ethanol (a.k.a. ethyl alcohol) | 18.94 |

Again, the solvent content controls the viscosity and more solvent will be required for the pre-layer and less solvent for the second layer.

Another formulation for dip coating devices, including three dimensional devices and other devices, includes a vehicle mixed with phase pure YBCO powder so that the formulation comprises from about 62 wt % to about 64 wt % phase pure YBCO powder and from about 36 wt % to about 38 wt % of a vehicle. The vehicle comprises from about 57 wt % to about 59 wt % terpineol, from about 37 wt % to about 39 wt % butoxyethyl acetate and from about 2 wt % to about 5 wt % binder. The terpineol and butoxyethyl acetate serve as solvents. The terpineol is preferably alpha-terpineol and the butoxyethyl acetate is preferably 2-butoxyethyl acetate. The preferred binders are acryloid, more preferably B-67™ acryloid and cellulose, more preferably a combination of T-200™ cellulose, N4™ cellulose and Ehec-Hi™ cellulose. Preferably, the vehicle and the dip coating formulation are free of dispersants as they are deemed unnecessary.

Yet another preferred dip coating formulation is as follows:

| | Preferred Weight % |
|---|---|
| Vehicle | |
| Alpha-terpineol | 57.85 |
| 2-Butoxyethyl acetate (a.k.a. “BCA”) | 38.61 |
| B-67 ™ acryloid (a.k.a. “paraloid”) | 1.58 |
| T-200 ™ ethylcellulose | 0.65 |
| Ehec-Hi ™ cellulose | 0.59 |
| N4 ™ cellulose | 0.72 |
| Dip Coating of Ink Formulation | |
| Phase pure YBa₂Cu₃O₆₊ₓ powder | 63 |
| Vehicle | 37 |

Again, solvents will control viscosity and additional solvent will be required for the pre-layer and less solvent for the second layer.

Other suitable formulations are disclosed in U.S. Pat. Nos. 5,527,765, 5,340,797, 5,789,347 and 6,119,025. Further, any of the formulations described herein may be provided in the form of a colloidal suspension or “sol-gel” formulation.

The foregoing detailed description has been given for clearness of understanding only, and no unnecessary limitations should be understood therefrom, as modifications would be obvious to those skilled in the art.

What is claimed:

1. A method for coating a superconducting film on a device, the method comprising:
providing a device;
coating a thin pre-layer of a superconducting precursor material on at least a portion of the device;
heat treating the thin pre-layer;
coating a second layer of the superconducting precursor material on the heat treated thin pre-layer; and
heat treating the second layer and the thin pre-layer.

2. The method of claim 1 wherein the heat treating of the thin pre-layer is carried out at a lower temperature than the heat treating of the second layer and thin pre-layer.

3. The method of claim 1 wherein the heat treating of the thin pre-layer is carried out at a temperature of less than 1000° C.

4. The method of claim 1 wherein the heat treating of the thin pre-layer is carried out at a temperature of less than 900° C.

5. The method of claim 1 wherein the heat treating of the thin pre-layer is carried out at a temperature ranging from about 750° C. to about 850° C.

6. The method of claim 1 where in the heat treating of the second layer and thin pre-layer is carried out at a temperature ranging from about 1000° C. to about 1100° C.

7. The method of claim 1 wherein the heat treating of the second layer and thin pre-layer is carried out at a temperature of about 1060° C.

8. The method of claim 1 wherein the thin pre-layer has a thickness ranging from about 250 Å to about 750 Å.

9. The method of claim 1 wherein the thin pre-layer has a thickness of about 500 Å.

10. The method of claim 1 wherein a combined thickness of the thin pre-layer and second layer ranges from about 40 μm to about 100 μm.

11. The method of claim 1 wherein the device is a polished device.

12. The method of claim 1 wherein the device is a mechanically polished metal device.

13. The method of claim 1 wherein the superconducting precursor material is provided in the form of a sol-gel preparation.

14. A method for coating a superconducting film on a portion of the a device while leaving another portion of the device uncoated and for controlling bleeding of superconducting materials onto the uncoated portion of the device during heat processing, the method comprising:
providing a device;
coating a thin pre-layer of a superconducting material onto a portion of the device leaving another portion of the device uncoated, the thin pre-layer having a thickness ranging from about 250 Å to about 750 Å;
heat treating the thin pre-layer film at a first temperature;
coating a second layer of the superconducting material on the thin pre-layer; and
heat treating the second layer and thin pre-layer at a second temperature, the second temperature being higher than the first temperature, the heat treated second layer and thin pre-layer having a combined thickness ranging from about 250 Å to about 750 Å.

15. The method of claim 14 wherein the first temperature ranges from about 750° C. to about 850° C.

16. The method of claim 14 wherein the second temperature ranges from about 1000° C. to about 1100° C.

17. The method of claim 14 wherein the second temperature is about 1060° C.

18. The method of claim 14 wherein the thin pre-layer has a thickness of about 500 Å.

19. The method of claim 18 wherein a combined thickness of the thin pre-layer and second layer ranges from about 40 μm to about 100 μm.

20. The method of claim 14 wherein the superconducting precursor material is provided in the form of a sol-gel preparation.

21. A method for coating a superconducting film on a device, the method comprising:
providing a device;
mechanically polishing the device;
coating at least one layer of superconducting precursor material on at least a portion of the device leaving another portion of the device uncoated; and
heat treating the superconducting material.

22. The method of claim 21 wherein the coating of at least one layer of superconducting material comprises
coating a thin pre-layer of a superconducting precursor material on said portion of the device, and
coating a second layer of the superconducting precursor material on the thin pre-layer, and the heat treating of the superconducting precursor material comprises
separately heat treating the thin pre-layer before the coating of the second layer onto the thin pre-layer which preceded the heat treating the second layer and thin pre-layer.

23. The method of claim 22 wherein the heat treating of the thin pre-layer is carried out at a lower temperature than the heat treating of the second layer and thin pre-layer.

24. The method of claim 22 wherein the heat treating of the thin pre-layer is carried out at a temperature of less than 1000° C.

25. The method of claim 22 wherein the heat treating of the thin pre-layer is carried out at a temperature of less than 900° C.

26. The method of claim 22 wherein the heat treating of the thin pre-layer is carried out at a temperature ranging from about 750° C. to about 850° C.

27. The method of claim 22 wherein the heat treating of the second layer and thin pre-layer is carried out at a temperature ranging from about 1000° C. to about 1100° C.

28. The method of claim 22 wherein the heat treating of the second layer and thin pre-layer is carried out at a temperature of about 1060° C.

29. The method of claim 22 wherein the thin pre-layer has a thickness ranging from about 250 Å to about 750 Å.

30. The method of claim 22 wherein the thin pre-layer has a thickness of about 500 Å.

31. The method of claim 22 wherein a combined thickness of the thin pre-layer and second layer ranges from about 40 μm to about 100 μm.

32. The method of claim 22 wherein the superconducting precursor material is provided in the form of a sol-gel preparation.

33. A method for coating a superconducting film on a portion of the a device while leaving another portion of the device uncoated and for controlling bleeding of superconducting materials onto the uncoated portion of the device during heat processing, the method comprising:
providing a mechanically polished zirconia device;
coating a thin pre-layer of a superconducting precursor material onto a portion of the device leaving another portion of the device uncoated, the thin pre-layer having a thickness ranging from about 250 Å to about 750 Å;
heat treating the thin pre-layer film at a first temperature;
coating a second layer of the superconducting precursor material on the thin pre-layer; and
heat treating the second layer and thin pre-layer at a second temperature, the second temperature being higher than the first temperature, the heat treated second layer and thin pre-layer having a combined thickness ranging from about 250 Å to about 750 Å;
wherein the first temperature is less than 900° C. and the second temperature ranges from about 1000° C. to about 1100° C.

34. An electromagnetic resonator comprising a conducting element comprising a zirconia device coated with superconducting material in accordance with the method of claim 1.

35. An electromagnetic resonator comprising a conducting element comprising a zirconia device coated with superconducting material in accordance with the method of claim 14.

36. An electromagnetic resonator comprising a conducting element comprising a zirconia device coated with superconducting material in accordance with the method of claim 22.

37. An electromagnetic resonator comprising a conducting element comprising a zirconia device coated with superconducting material in accordance with the method of claim 33.
